(19) United States
(12) Patent Application Publication
(10) Pub. No.: US 2005/0023489 A1
(43) Pub. Date: Feb. 3, 2005

(54) Chip type photo coupler

(75) Inventor: Satoru Kikuchi, Tokyo (JP)

Correspondence Address: BROWDY AND NEIMARK, P.L.L.C.;624 NINTH STREET, NW, SUITE 300, WASHINGTON, DC, 20001-5303, US

(73) Assignee: Citizen Electronics Co., Ltd., Yamanashi (JP)

(21) Appl. No.: 10/899,021

(22) Filed: Jul. 27, 2004

(30) Foreign Application Priority Data
Jul. 29, 2003 (JP) 2003-202749

(51) Int. Cl. H01J 40/14; G02B 6/30

(52) U.S. Cl. 250/551; 250/239; 250/214 R

(57) ABSTRACT

A chip type photo coupler, comprising an insulative substrate, a light emitting element and a light receiving element mounted on an upper surface of the insulative substrate, and a sealing body sealing the light emitting element and the light receiving element mounted on the insulative substrate, the sealing body being formed by a transparent resin, a reflective layer of a reflective material being provided on a surface of the sealing body, receiving light from the light emitting element.

### CROSS REFERENCE TO RELATED APPLICATION

The application claims the priority benefit of Japanese Patent Application No.2003-202749, filed on Jul. 29, 2003, the entire descriptions of which are incorporated herein by reference.

### BACKGROUND OF THE INVENTION

1. Field of the Invention

The present invention relates to a chip type photo coupler capable of obtaining a signal from an output side with non-contact, in response to a signal from an input side, particularly to a photo coupler of a surface-mounted reflective chip type.

2. Description of Related Art

Recently, a photo coupler of a surface-mounted reflective chip type, which is sealed by a resin is classified into a face type in which a light emitting element or, for example, a light emitting diode and a light receiving element or, for example, a photo diode or phototransistor are disposed to face with respect to each other on upper and lower surfaces of an insulative substrate, respectively and a reflective type in which the light emitting element and the light receiving element are disposed side by side on the upper surface of the insulative substrate. In particular, a type in which an upper surface of a resin sealing the photo coupler has a reflective effect, mainly, with respect to the photo coupler of a surface-mounted reflective chip type has been widely used, for example, as disclosed in Japanese Patent Laid-Open 2001-358361, page 3, FIG. 1.

In the photo coupler as described in the above patent document, a pair of inside upper electrodes 2a and 2b, and a pair of inside upper electrodes 3a and 3b are formed on one surface of the insulative substrate 1, as shown in FIG. 2. A light emitting element 4 having at an upper surface a light emitting surface 4a and a light receiving element 5 having at an upper surface a light receiving surface 5a are disposed on the inside upper electrodes 2a, 2b and 3a, 3b and connected with them through wire bonding, in other words, by metal thin wires 6 and 7.

The inside upper electrodes 2a, 2b and 3a, 3b are connected through semi-circular through hole electrodes 8a, 8b and 9a, 9b with a pair of outside lower electrodes 10a and 10b, and a pair of outside lower electrodes 11a and 11b formed on another surface of the insulative substrate 1.

Light emitted from the light emitting surface 4a of the light emitting element 4 is passing through a transparent resin 12, reflected by a generally conical reflective surface of a light shielding resin 13, and reached to the light receiving surface 5a of the light receiving element 5 to perform transmitting optical signal.

However, in the chip type photo coupler in prior art as described above, effects on a characteristic of the chip type photo coupler are significantly presented depending on variation of shape of the reflective surface formed at a boundary of the transparent resin 12 and the light shielding resin 13.

That is to say, when the reflective surface is formed into an improper reflective state, as shown by a dotted line in FIG. 2, there is a problem that light emitted from the light emitting surface 4a of the light emitting element 4 is reflected on the reflective surface and thereafter the reflected light is moved in a different direction without being directed to the light receiving surface 5a of the light receiving element 5. Therefore, an amount of light directed to the light receiving surface 5a is less.

Moreover, in the conventional art as described above, a shape of the transparent resin 12 is formed into an irregular shape in order to have a reflective effect, and resin forming of two times that after the transparent resin is formed, the shielding resin 13 is formed on the transparent resin 12, is required, and therefore the forming step is difficult and the cost for forming is also increased.

Moreover, a displacement between the light emitting element 4 and the light receiving element 5 which are mounted on the insulative substrate, is generated depending on a mechanical accuracy of die bond, and if the reflective surface of the transparent resin 12 is not formed accurately designed, there is a possibility that these factors will affect a characteristic of the chip type photo coupler.

Furthermore, there is a problem that it is difficult to thin a manufactured chip type photo-coupler because resin forming step is needed twice for forming layers of the transparent resin 12 and the shielding resin 13.

### SUMMARY OF THE INVENTION

The present invention has been made in view of the aforementioned problems in the prior art, an object of the present invention is to provide a thinned and inexpensive chip type photo coupler for which efficient use of light is available and its manufacturing step is simplified.

To attain the above object, a chip type photo coupler according to an aspect of the present invention comprises an insulative substrate, a light emitting element and a light receiving element, which are mounted on an upper surface of the insulative substrate, and a sealing body sealing the light emitting element and the light receiving element mounted on an upper surface of the insulative substrate.

The sealing body is formed by a transparent resin.

A reflective layer formed by a reflective material is provided on a surface of the sealing body, receiving light from the light emitting element.

Here, for one of the preferred embodiments, the reflective layer is formed on an upper surface of the sealing body, which is evenly formed. The reflective material comprises a metal of Al, Ag or the like, for example.

For another embodiment, another reflective layer is provided on a side surface of sealing body. The side-surface reflective layer is made of the same material as the reflective material formed on the upper surface of the sealing body.

For still another embodiment, the reflective layer is provided on a flat upper surface of the sealing body and a reflective frame having a reflective surface is provided on the side surface of sealing body.

The reflective surface of the reflective frame is formed with a plating of a metal or a resin.

### BRIEF DESCRIPTION OF THE DRAWINGS

FIG. 1 is a sectional view showing one embodiment of a chip type photo coupler according to the present invention.

FIG. 2 is a sectional view of a conventional chip type photo coupler.

### DETAILED DESCRIPTION OF THE PREFERRED EMBODIMENTS

Hereinafter, a chip type photo coupler according to the present invention will be explained with reference to the accompanying drawings.

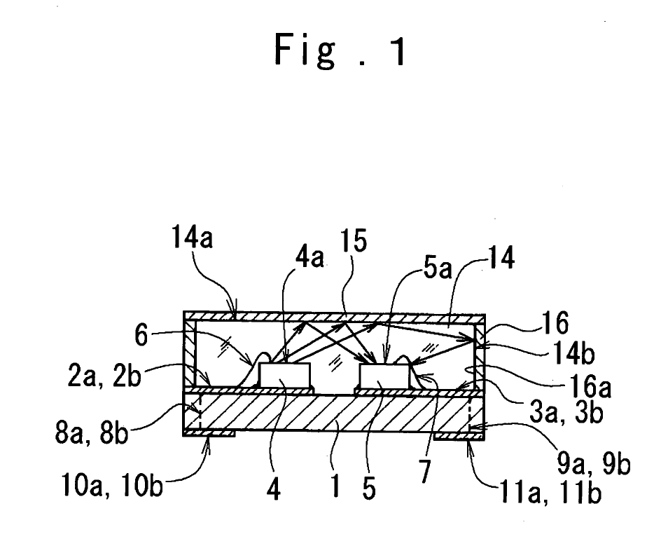

FIG. 1 illustrates an embodiment of the chip type photo coupler of the present invention.

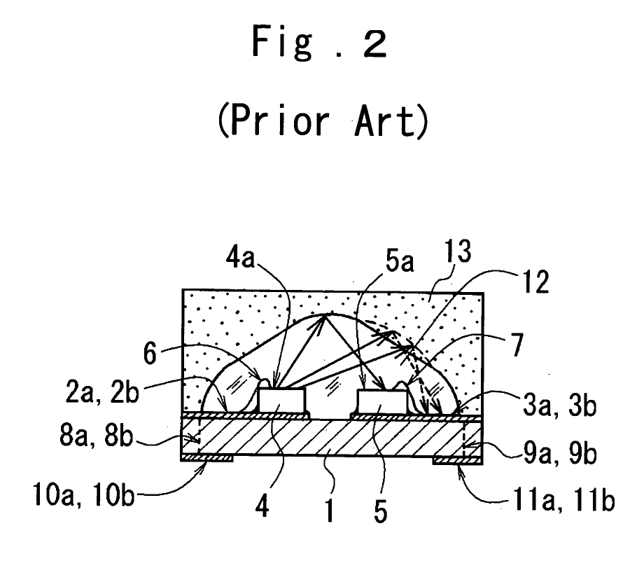

In FIG. 1, the similar reference numerals are attached to the similar parts as in FIG. 2.

In FIG. 1, the chip type photo-coupler includes an insulative substrate 1 made of glass epoxy resin, and a pair of inside upper electrodes 2a, 2b and a pair of inside upper electrodes 3a, 3b, which are placed on an upper surface of the insulative substrate 1.

A light emitting element 4 and a light receiving element 5 are disposed with a space apart from each other and side by side on the inside upper electrodes 2a, 2b, and 3a, 3b. The light emitting element 4 comprises, for example, a light emitting diode, whose upper surface is formed into a light emitting surface 4a. The light receiving element 5 comprises, for example, a photodiode or phototransistor, whose upper surface is formed into a light receiving surface 5a. The light emitting element 4 and light receiving element 5 are connected with the inside upper electrodes 2a, 2b and 3a, 3b by wire-bonding connection, that is to say, metallic thin wires 6 and 7, respectively.

The inside upper electrodes 2a, 2b, 3a and 3b are electrically with a pair of outside lower electrodes 10a and 10b, and a pair of outside lower electrodes 11a and 11b through semi circular shaped through-holes 8a, 8b and 9a, 9b, respectively.

A sealing body 14 is attached to the insulative substrate 1 so as to seal the light emitting element 4 and the light receiving element 5. The sealing body 14 is formed by a transparent resin, a surface of the sealing body 14 receiving light from the light emitting surface 4a of the light emitting element 4, for example, an upper surface 14a thereof is provided with a reflective layer 15.

More specifically, the upper surface 14a of the sealing body 14 is evenly formed and the reflective layer 15 is provided on the even upper surface 14a formed by a reflective material having a reflective effect of a metal, for example, Al, Ag or the like through evaporation method, plating method or transfer method, for example.

Moreover, it is preferable that another reflective layer of the same material as the aforementioned reflective material is provided on at least one side surface 14b of the sealing body 14 in order to acquire more reflective effect.

Furthermore, a reflective frame 16 may be provided to cover the side surface 14b of the sealing body 14, instead of providing another reflective layer formed by the same material as the reflective layer 15.

The reflective frame 16 has a reflective layer 16a, which is formed by plating a metal or a resin on an inner surface of the reflective frame 16.

A function of the chip type photo coupler structured as described above will be explained below.

In FIG. 1, light emitted from the light emitting surface 4a of the light emitting element 4 is reflected on the reflective layer 15 formed on the upper surface 14a of the sealing body 14 having translucency and received efficiently on the light receiving surface 5a of the light receiving element 5. The light from the light emitting element 4 is also reflected on the reflective layer formed to cover the side surface 14b of the sealing body 14 or the reflective layer 16a of the reflective frame 16 and received on the light receiving surface 4a of the light receiving element 4. In this case, light leaked from the sealing body to outside is reduced by means of the reflective frame 16. If a plurality of similar photo couplers formed as described above are used adjacently to each other, the reflective frame 16 has a function that one shields light from the other, and light generated from the inside of one photo coupler is closed within the one photo coupler and therefore an efficiency use of light is available.

As a result, even if a slight displacement between the light emitting element 4 and the light receiving element 5 occurs, light closed within the photo coupler can reach sufficiently to the light receiving element 5, because the upper surface 14a of the sealing body 14 is flat.

In addition, because the upper surface 14a of the sealing body 14 is flat, even if the sealing body is rectangular, sufficient reflective effect is obtained. It is, also, possible to ease formation of the reflective layer 15 by means of the evaporation, plating, transfer or the like, to simplify manufacturing processes and to accomplish cost down of the photo coupler.

The photo coupler can be thinned than a conventional structure because the sealing body 14 is formed by one layer.

As described above, according to the present invention, light emitted from the light emitting element is reflected on the reflective layer, and then received efficiently on the light receiving element, without loss. In particular, because the reflective layer has a flat surface, variation of shape of the reflective surface in characteristic of the conventional photo coupler is solved. Because the photo coupler in this invention is simple in shape, the manufacturing processes are simplified. Therefore a thinned and inexpensive chip type photo coupler can be provided.

Although the preferred embodiments of the present invention have been described, the present invention is not limited to these embodiments, various modifications and changes can be made to the embodiments.

1. A chip type photo coupler, comprising:
an insulative substrate;
a light emitting element and a light receiving element which are mounted on an upper surface of the insulative substrate; and
a sealing body sealing the light emitting element and the light receiving element mounted on an upper surface of the insulative substrate,
said sealing body being formed by a transparent resin,
a reflective layer formed by a reflective material being provided on a surface of the sealing body, receiving light from the light emitting element.

2. The chip type photo coupler according to claim 1,
wherein said reflective material comprises a metal including Al and Ag.

3. The chip type photo coupler according to claim 1,
further comprising another reflective layer provided on at least one side surface of the sealing body.

4. The chip type photo coupler according to claim 1,
wherein said reflective layer is provided on a flat upper surface formed on sealing body and a reflective frame having a reflective layer is provided on at least one side surface of sealing body.

5. The chip type photo coupler according to claim 1,
wherein said reflective layer of the reflective frame is formed by plating a metal or a resin on inner surface of the reflective frame.
